(19) United States
(12) Patent Application Publication
(10) Pub. No.: US 2012/0005858 A1
(43) Pub. Date: Jan. 12, 2012

(54) WHEEL ASSEMBLY WITH SINGLE FIXING ARM

(75) Inventor: Chu-Shan Lai, Taipei (TW)

(73) Assignee: HERSON PLASTIC CO. LTD., Hsin Chuang City (TW)

(21) Appl. No.: 12/830,575

(22) Filed: Jul. 6, 2010

(51) Int. Cl. B60B 33/00

(52) U.S. Cl. 16/45; 16/35 R

(57) ABSTRACT

The present invention relates to a wheel assembly with a single fixing arm capable of being disposed on a luggage, the wheel assembly comprises: an assembly body, a wheel frame, a first pad, a circular plate, a ring pad, an assembly shaft, an auxiliary wheel, a bearing mechanism, and a wheel, wherein the assembly shaft being punched through assembly body, the wheel frame, the first pad, the circular plate, and the ring pad, so as to combine the assembly body and the wheel frame. The auxiliary wheel is adapted to maintain the stability of the wheel when the wheel is on a rotating state; moreover, the wheel can stop rotating when applying a force to the auxiliary wheel.

### BACKGROUND OF THE INVENTION

1. Technical Field

The present invention relates to a wheel assembly, and more particularly, to a wheel assembly with a single fixing arm, in which, the single fixing arm is used to fix a wheel, and an auxiliary wheel is adapted to maintain the stability of the wheel when the wheel is on rotating.

2. Description of Related Art

Generally, a luggage usually has at least two wheel assemblies, and then a user is able to drag the luggage without using too much strength. A conventional wheel assembly is most designed to a formation of dual fixing arms for fastening a wheel. Referring to FIG. 1, which illustrates a stereo view of the conventional wheel assembly for the luggage, as shown in FIG. 1, the conventional wheel assembly 10′ is secured on the luggage 22′ through four first screws 12′ and includes: a fixing base 30′, an assembly member 40′, a wheel frame 50′, and a wheel 60′. The fixing base 30′ has a housing 39′ and four second threaded holes 38′, wherein four the second threaded holes 38′ are used to cooperate with the four first screws 12′. The assembly member 40′ has a large-diameter portion 42′, a small-diameter portion 44′ and four third threaded holes 426′, the assembly member 40′ is connected to the fixing base 30′ via the small-diameter portion 42′. Moreover, the assembly member 40′ is combined with the fixing base 30′ by way of screwing the four second screw 46′ into the four third threaded holes 426′, respectively. The wheel frame 50′ has a base portion 51′ and two fixing arms 52′, the base portion 51′ is connected to the assembly member 40′, and the wheel 60′ is fastened to the two fixing arms 52′ through a shaft 62′.

The wheel assembly 10′ described above is a wheel device often applied to the conventional luggage, the wheel 60′ of the wheel assembly 10′ is fixed by the two fixing arms 52′, such that the user do not worry about that the wheel 60′ could fall off after long-term use as well as wear and tear.

However, the designation of the dual fixing arms not only causes the high manufacturing cost of the wheel frame 50′ but also confines the formation of the wheel 60′. Besides, due to the assembly member 40′ is fastened to the fixing base 30′ via the second screws 46′, the assembly member 40′ could out of the fixing base 30′ owing to the second screws 46′ is loose after the luggage is long-term used.

Accordingly, in view of the drawbacks and shortcomings of conventional wheel assembly, the inventor of the present application has made great efforts to make inventive research thereon and eventually provided a wheel assembly with a single fixing arm according to the present invention.

### BRIEF SUMMARY OF THE INVENTION

The primary objective of the present invention is to provide a wheel assembly with a single fixing arm capable of being disposed on a luggage, in the wheel assembly, the single fixing arm is used to fix a wheel, and an auxiliary wheel is adapted to maintain the stability of the wheel when the wheel is on a rotating state, so that, the cost-down and the lightweight of the wheel assembly is carried out on the premise that the functions of the wheel assembly are not impacted.

Accordingly, to achieve the abovementioned primary objective, the inventor proposes a wheel assembly with a single fixing arm capable of being disposed on a luggage, the wheel assembly comprises: an assembly body, a wheel frame, a first pad, a circular plate, a ring pad, an assembly shaft, an auxiliary wheel, a bearing mechanism, and a wheel, wherein the assembly body has a first assembly portion, a second assembly portion and a first through hole, the first through hole passes through the first assembly portion and the second assembly portion.

The wheel frame is connected to the second assembly portion and has a base and a fixing arm, wherein the base has a second through hole. The first pad is connected to the second assembly portion and has a first aperture disposed in the center thereof, the first aperture corresponds to the second through hole. The circular plate is connected to the first pad and the ring pad is connected to the circular plate.

The assembly shaft is used to punch through the first through hole, the second through hole, the first pad, the circular plate, and the ring pad, so as to combine the assembly body and the wheel frame. The auxiliary wheel is connected to the circular plate. The bearing mechanism is disposed on the fixing arm and has an axle. Finally, the wheel is attached to the bearing mechanism via the axle and also connects to the auxiliary wheel, wherein the auxiliary wheel is adapted to maintain the stability of the wheel when the wheel is on a rotating state, moreover, applying a force to the auxiliary wheel being able to stop rotating state of the wheel.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a conventional wheel assembly for a luggage;

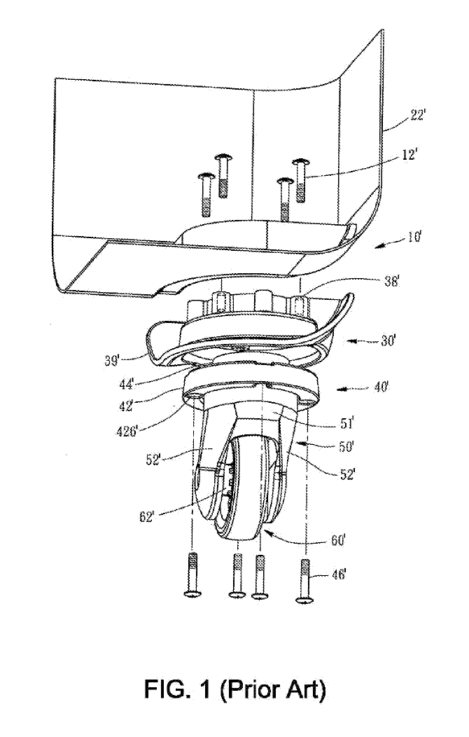

FIG. 2 is the stereo view of a wheel assembly with a single fixing arm according to the present invention;

FIG. 3 is an exploded view of the wheel assembly with the single fixing arm according to the present invention;

FIG. 4 is an assembled stereo view of an assembly body and a wheel frame of the wheel assembly with the single fixing arm;

FIG. 5 is the stereo view of a ring pad, a circular plate, an auxiliary wheel, and a wheel of the wheel assembly with the single fixing arm.

### DETAILED DESCRIPTION OF THE INVENTION

To more clearly describe a wheel assembly with a single fixing arm according to the present invention, an embodiment of the present invention will be described in detail with reference to the attached drawings hereinafter.

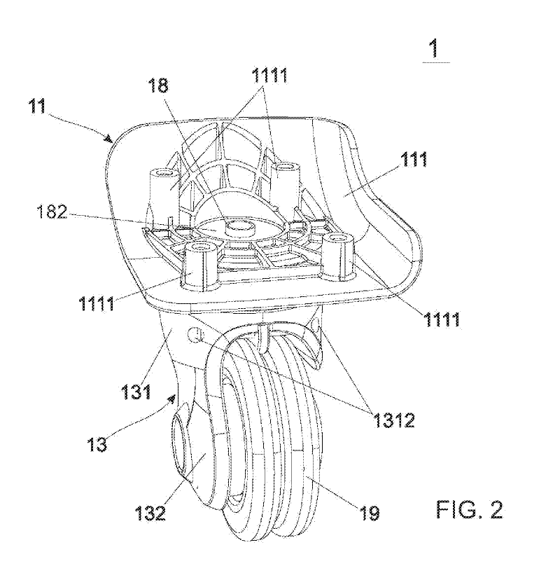

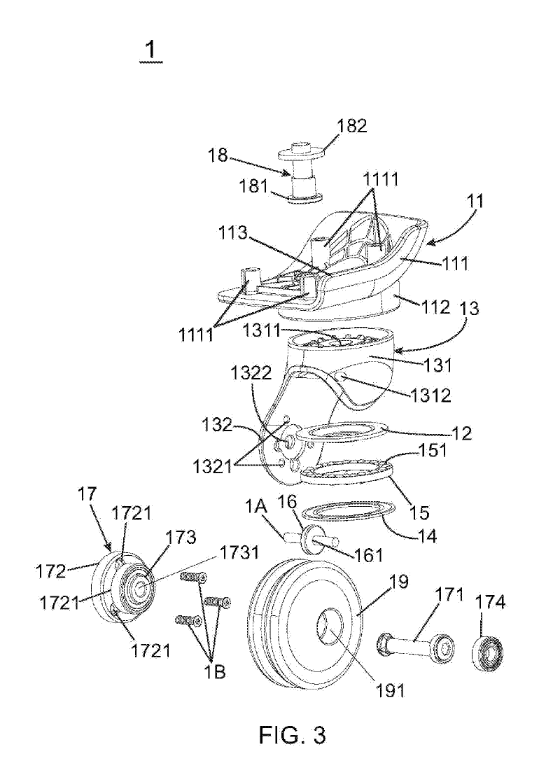

Referring to FIGS. 2 and 3, which illustrate a stereo view and an exploded view of the wheel assembly with the single fixing arm according to the present invention. The wheel assembly 1, having the single fixing arm and capable of being disposed on a luggage, the wheel assembly 1 includes: an assembly body 11, a wheel frame 13, a first pad 12, a circular plate 15, a ring pad 14, an assembly shaft 18, an auxiliary wheel 16, a bearing mechanism 17, a wheel 19, and a plug-pin 1A.

The assembly body 11 has a first assembly portion 111, a second assembly portion 112 and a first through hole 113, wherein the first through hole 113 passes through the first assembly portion 111 and the second assembly portion 112. As shown in FIG. 3, the first assembly portion 111 further includes a plurality of combination pillars 1111, each combination pillar 1111 has a threaded hole. The assembly body 11 can be disposed on the luggage by way of screwing a plurality of screws into the plurality of combination pillar 1111, respectively.

The wheel frame 13 is connected to the second assembly portion 112 and has a base 131 and a fixing arm 132, wherein the base 131 further includes a second through hole 1311 and two opposite pin holes 1312; Moreover, the fixing arm 132 includes a plurality of third apertures 1321 and an axle opening 1322.

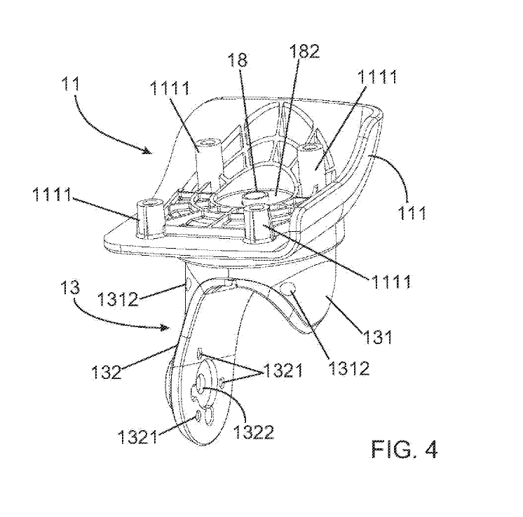

The first pad 12 is connected to the second assembly portion 112 and has a first aperture 121 disposed in the center thereof. In the embodiment of the present invention, the first aperture 121 corresponds to the second through hole 1311. The circular plate 15 is connected to the first pad 12 and has a plurality of second apertures 151 for respectively disposing a plurality of balls (the balls are not illustrated in FIGS. 2 and 3). The ring pad 14 is connected to the circular plate 15. The assembly shaft 18 is used to punch through the first through hole 113, the second through hole 1311, the first pad 12, the circular plate 15, and the ring pad 14, so as to combine the assembly body 11 and the wheel frame 13. In the embodiment of the present invention, one end of the assembly shaft 18 is formed a plate portion 181, and another end of the assembly shaft 18 is disposed a second pad 182. Please refer to FIG. 4 together, which illustrates an assembled stereo view of the assembly body and the wheel frame of the wheel assembly with the single fixing arm. As shown in FIG. 4, after the assembly shaft 18 combines the assembly body 11, the first pad 12 and the wheel frame 13, the plate portion 181 and the second pad 182 are able to steady the combined state of the above three members.

The auxiliary wheel 16 has a second opening 161 in the center thereof. In the embodiment of the present invention, the plug-pin 1A is used to insert into two pin holes 1312 for fastening the auxiliary wheel 16 on the wheel frame 13, so as to make the auxiliary wheel 16 connect to the circular plate 15. The bearing mechanism 17 is disposed on the fixing arm 132 and includes: an axle 171; a base portion 172, having a plurality of fourth apertures 1721 corresponding to the plurality of third apertures 1321, so that the base portion 172 can be attached to the fixing arm 132 by means of screwing a plurality of screws 1B to the fourth apertures 1721 and the third apertures 1321, respectively; an axle portion 173, disposed on the base portion 172 and has a bearing opening 1731 for inserting the axle 171; and a fixing member 174, used for securing the axle 171.

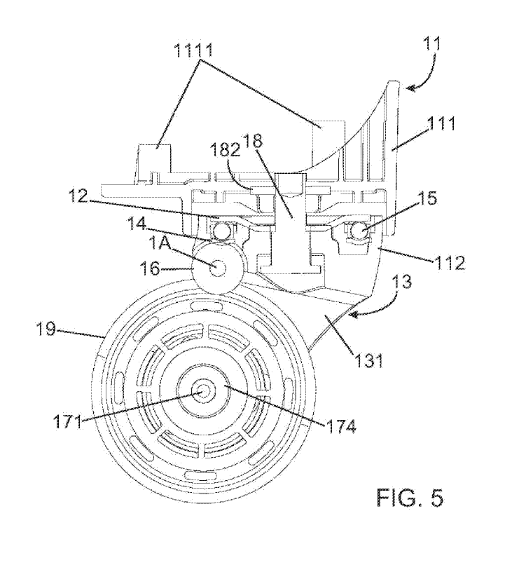

The wheel 19 has a first opening 191 in the center thereof. In the embodiment of the present invention, the axle 171 inserts the wheel 19 via the first opening 191, and furthermore, the axle 171 inserts the bearing opening 1731, so that, the wheel 19 is fastened on the bearing mechanism 17. Referring to FIG. 5 together, which illustrates the stereo view of the ring pad, the circular plate, the auxiliary wheel, and the wheel of the wheel assembly with the single fixing arm. As shown in FIG. 5, after the wheel 19 is fastened on the bearing mechanism 17, the wheel 19 connects to the auxiliary wheel 16 at the same time, wherein the auxiliary wheel 16 is able to maintain the stability of the wheel 19 when the wheel 19 is on the rotating state, moreover, applying a force to the auxiliary wheel 16 can stop rotating state of the wheel 19. Besides, when the wheel 19 is fastened to the bearing mechanism 17, meanwhile, the wheel 19 is firmly fixed on the bearing mechanism 17 by disposing the fixing member 174 on the axle 171.

Thus, the wheel assembly with the single fixing arm according to the present invention has been completely and clearly disclosed. In summary, the present invention has the following advantages:
1. The wheel is attached to the wheel frame by merely using one single fixing arm (i.e., the fixing arm 132), So that, opposing to the conventional wheel assembly with two fixing arms, it is well known that the manufacturing cost of the wheel assembly according to the present invention is less than the conventional wheel assembly.
2. Inheriting the point (1) described above, due to the wheel frame only has the single fixing arm, whole weight of the wheel assembly with the single fixing arm is reduced.
3. Disposing the auxiliary wheel above the wheel that is not only able to maintain the stability of the wheel but also can stop the rotating state of the wheel by applying the force to the auxiliary wheel, i.e., the auxiliary wheel has the braking function.

The above description is made on an embodiment of the present invention. However, this embodiment is not intended to limit scope of the present invention, and all equivalent implementations or alterations within the spirit of the present invention still fall within the scope of the present invention.

I claim:

1. A wheel assembly with a single fixing arm capable of being disposed on a luggage, comprising:
an assembly body, having a first assembly portion, a second assembly portion and a first through hole, wherein the first through hole passes through the first assembly portion and the second assembly portion;
a wheel frame, being connected to the second assembly portion and having a base and a fixing arm, wherein the base having a second through hole;
a first pad, being connected to the second assembly portion and having a first aperture disposed in the center thereof, the first aperture corresponding to the second through hole;
a circular plate, being connected to the first pad and having a plurality of second apertures;
a ring pad, being connected to the circular plate;
an assembly shaft, being punched through the first through hole, the second through hole, the first pad, the circular plate, and the ring pad, so as to combine the assembly body and the wheel frame;
an auxiliary wheel, being connected to the circular plate;
a bearing mechanism, being disposed on the fixing arm and having an axle; and
a wheel, being attached to the bearing mechanism via the axle and also being connected to the auxiliary wheel, wherein the auxiliary wheel is adapted to maintain the stability of the wheel when the wheel is on a rotating state, moreover, applying a force to the auxiliary wheel being able to stop rotating state of the wheel.

2. The wheel assembly with the single fixing arm of claim 1, further comprising a plug-pin, capable of plugging the auxiliary wheel on the base.

3. The wheel assembly with the single fixing arm of claim 1, wherein the first assembly portion further comprises a plurality of combination pillars, each combination pillar having a threaded hole.

4. The wheel assembly with the single fixing arm of claim 2, wherein the base further comprises two opposite pin holes for inserting the plug-pin.

5. The wheel assembly with the single fixing arm of claim 1, wherein one end of the assembly shaft is formed a plate portion, and another end of the assembly shaft is disposed a second pad, after the assembly shaft combines the assembly body, the first pad and the wheel frame, the plate portion and the second pad being able to steady the combined state of the above three members.

6. The wheel assembly with the single fixing arm of claim 1, wherein the fixing arm comprises a plurality of third apertures and an axle opening.

7. The wheel assembly with the single fixing arm of claim 3, wherein the bearing mechanism further comprises:
a base portion, having a plurality of fourth apertures corresponding to the plurality of third apertures, so that the base portion can be attached to the fixing arm by means of screwing a plurality of screws to the fourth apertures and the third apertures, respectively;
an axle portion, being disposed on the base portion and having a bearing opening for inserting the axle; and
a fixing member, being used for securing the axle, wherein after the axle is inserted the wheel and the bearing opening, so that, the wheel is firmly fastened on the bearing mechanism by disposing the fixing member on the axle.

8. The wheel assembly with the single fixing arm of claim 1, wherein a first opening is disposed in the center of the wheel and capable of being inserted through by the axle.

9. The wheel assembly with the single fixing arm of claim 2, wherein a second opening is disposed in the center of the auxiliary wheel and capable of being inserted through by the plug-pin.
